(19) United States
(12) Patent Application Publication
(10) Pub. No.: US 2021/0326943 A1
(43) Pub. Date: Oct. 21, 2021

(54) System and method for obtaining advice on product or service upon request in the online broadcast mode "Eyezon"

(71) Applicant: OBCHESTVO S OGRANICHENNOI OTVETSTVENNOSTIU "REPORT, gorod Ivanovo (RU)

(72) Inventors: Dragorad Knezi, Sombor (RS); Anton Lubohinets, Brest (BY); Vladislav Klimuk, Biala Podlaska (PL)

(21) Appl. No.: 17/266,974

(22) PCT Filed: Jun. 17, 2020
(86) PCT No.: PCT/RU2020/000290

§ 371 Date: Feb. 8, 2021

(30) Foreign Application Priority Data
Feb. 14, 2020 (RU) 2020107043

(51) Int. Cl. G06Q 30/02; G06Q 30/06

(52) U.S. Cl. CPC G06Q 30/0282; G06Q 30/0641; G06Q 30/0639

(57) ABSTRACT

A system (and method) for providing information is presented. The system operates during remote, online purchasing (selling) of goods and (or) services, namely, by adding an option for a live video broadcast in real time at a user request to a graphics, photos, or text description of an object or place provided on the product webpage of any online platform (site). A live video broadcasting seeking additional information regarding an item (product or service) is carried out on the same webpage of the site where the graphic or text description thereof is provided, without going over and using other services or tools for exchanging video, audio or text messages, and also without using video call tools or services.

### CROSS-REFERENCE TO RELATED APPLICATIONS

This application is a US national stage under 35 USC 371 of PCT/RU2020/000290 filed on Jun. 17, 2020, which claims priority to Russian application no. 2020107043 filed on Feb. 14, 2020. The entire content of these applications is incorporated by reference herein.

### FIELD OF THE INVENTION

The claimed group of inventions relates to automated information technologies.

### BACKGROUND OF THE INVENTION

The following analogs are known from the prior art: https://www.goinstore.com—the disadvantage of which is limited functionality, and https://www.brand.live—the disadvantage of which is the lack of upon request option.

The task of the claimed group of inventions is to eliminate the disadvantages of the prior art.

### SUMMARY OF THE INVENTION

The technical result when using the proposed group of inventions consists in expanding the functionality of the entire procedure for remote purchasing (selling) of goods and (or) services, namely, in providing the possibility of switching from a visual or text description of an object or place provided on the page of any online platform (site) to individual video broadcast thereof in real-time mode at user request, as well as to maximize the use of current resources, for example, trading and industrial sites.

### BRIEF DESCRIPTION OF THE DRAWINGS

The teachings of the present invention can be readily understood by considering the following detailed description in conjunction with the accompanying drawings of the various embodiments and permutations of the invention, in which:

FIG. 1 schematically depicts a system of one embodiment of the present invention;

FIG. 2 is a flow chart of the steps performed in one embodiment of the present invention;

### DETAILED DESCRIPTION OF THE INVENTION

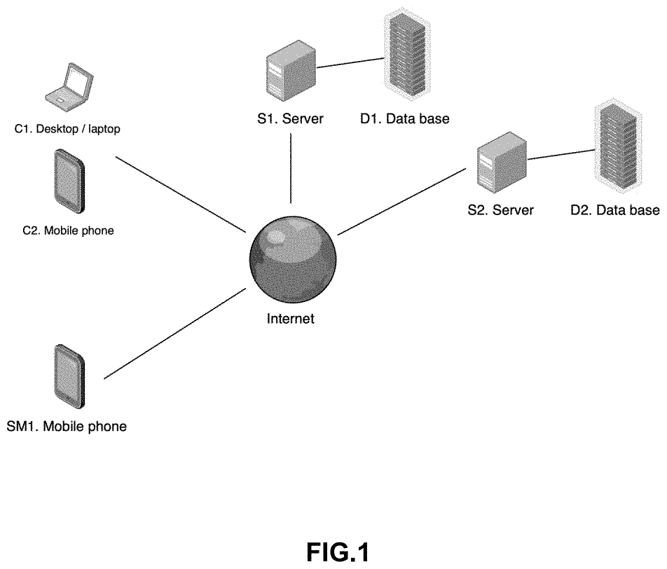

The task is solved, and the claimed technical result is achieved when using the claimed group of inventions comprising a system and processor-implemented method for obtaining advice on a product or service upon request in online broadcast mode, which system and method comprise the following functional blocks (see FIG. 1):

Client (C1, e.g., desktop/laptop, C2, e.g., mobile phone);

Manager/Seller (SM1, e.g., mobile phone);

Main server (S1);

Streaming server (S2);

Main server database (D1);

Streaming server database (D2); all of the above connected to the Internet and comminicatively coupled as shown in FIG. 1;

wherein at the boot or setup stage:

the Client (C1, C2) enters the website/mobile application of the store; when going to the product page, the Client (C1, C2) sees the K1 button; when the K1 button is pressed, the Client's device (C1, C2) sends a request to the server (S1), which server processes the request and performs search for sellers (SM1) connected to the button K1 through the database (D1) on/in the website/mobile application of the store; the server (S1) returns a response to the Client's device (C1, C2), and interface with a field for entering a request is loaded on the client's device,

wherein at the step of sending the request:

the Client (C1, C2) enters his (her) request in the field for entering a request and clicks the K2 button to send it; when pressing the “send” button K2, the Client's device (C1, C2) sends a request to the server (S1); the server (Si) processes the request and forwards it to the seller(s) (SM1); the seller(s) (SM1) in turn receives a PUSH notification to the device on which the mobile application is installed,

wherein at the step of responding to the request:

the Seller(s) (SM1), when clicking on the notification, switches to the mobile application, where he (she) sees a list of requests; when clicking on the request, the seller (SM1) can either respond to it or reject it; if the seller (SM1) responds to the request, then the seller's device (SM1) sends a request to the server (S1), the server (Si) processes the request, creates a room between the seller (SM1) and the client (C1, C2), and at this moment it sends a response to the devices of other sellers, and the given request is deleted from them; the Seller (SM1) can respond to the client's request (C1, C2) with photo, audio, video and/or live broadcast; when clicking on the Live broadcast button K3, the seller's device (SM1) sends a request to the server (S1) and opens the camera, the server (Si) processes the request and sends a request to the Server (S2), which server generates a link to the live broadcast, then the Server (S2) responds to the request of the Server (Si) and transmits the link to the live broadcast,

wherein at the step of receiving a response:

the Server (S1) transmits the received link to the client's device (C1, C2); the client (C1, C2) in turn receives a notification about the start of the live broadcasting and sees the K4 button; when it is pressed, a window is opened on the client's device where the client (C1, C2) watches the live broadcasting from the seller (SM1), wherein the client (C1, C2) can use an input field in this window to communicate with the seller (SM1) during the live broadcasting.

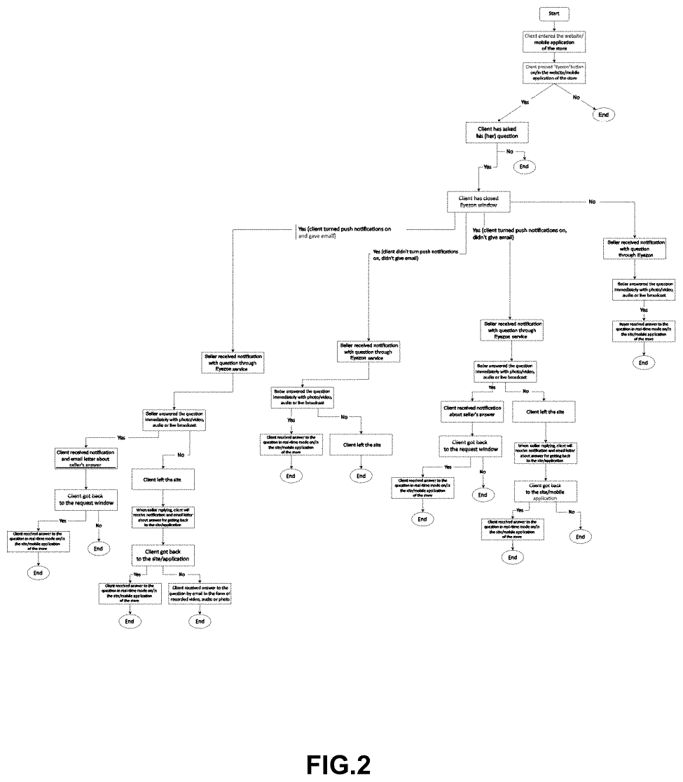

The claimed group of inventions provides the switching from a visual or text description of an object or place provided on the page of any online platform (site) to individual video broadcast thereof in real-time mode at user request (see the example in FIG. 2). A live video broadcasting of an object or place is carried out on the same page of the site where the visual or text description thereof is provided, without going over and using other services or tools for exchanging video, audio or text messages, and also without using video call tools or services.

To switch from the visual or text description of the object presented on the site page, the user clicks on a button, icon or image to which the Eyezon script is connected. After clicking, a pop-up window appears on the same object description page, in which window a clarifying question or wishes for a live video broadcast about an object or place of interest can be entered. This request is received by the user connected to the Eyezon service, thus, even before the start of the live video broadcasting, the one who will show it, has maximum information about the object or place the site user is interested in. A person responding to the request with a live video broadcast can perform it from any geographical point.

The individual live video broadcast is displayed in the same pop-up window where the site user has submitted the request. Therefore, for the user, the switching from the visual or text description of the object or place to the direct individual video broadcast occurs on the same page of the site where he is staying. In the same pop-up window displaying the live broadcast, the site user has the opportunity to ask clarifying questions using text or audio messages without using third-party video, audio or text messaging services or tools. After completing the live video broadcasting, the site user can close the pop-up window and continue his actions on the site page where he was staying all this time.

As illustrated in FIG. 2, in one embodiment of the present invention, at step 201, on the Client device, Client or user entered the website/mobile application of the store. At step 203, Client presses Eyezon button on the website/mobile application of the store. At step 205, the Client has asked his (her) question. At step 207, Client has closed the Eyezon window. If Client has not closed the Eyezon window, then at step 209, Seller received notification with Client's question through Eyezon. At step 211, Seller answered the question immediately with photo/video, audio or live broadcast. At step 213, Client or Buyer received answer to the question in real-time mode on the site/mobile application of the store.

If If Client has closed the Eyezon window at step 207 and Client turned PUSH notification on and gave email address, then, at step 215, Seller received notification with Client question through Eyezon service. If the Seller is available, at step 217 Seller answered the question immediately with photo/video, audio or live broadcast. Then at step 219, Client received notification and email letter about Seller's answer. If Client got back to the request window in step 221, then at step 223 Client received answer to the question in real-time mode on the site/mobile application of the store.

Going back to step 215, if the Seller is not available and did not answer the question immediately with photo/video, audio or live broadcast in step 217, then at step 225, Client left the site. At step 227, when the Seller has replied, Client will receive notification and email letter about answer for getting back to the site/application. If Client got back to the site/application in step 229, then in step 231, Client received answer to the question in real-time mode on the site/mobile application of the store. If Client did not get back to the site/application in step 229, then in step 231, Client received answer to the question by email in the form of recorded video, audio or photo.

If If Client has closed the Eyezon window at step 207 and Client turned PUSH notification on but did not give email address, then, at step 235, Seller received notification with Client question through Eyezon service. If the Seller is available, at step 237 Seller answered the question immediately with photo/video, audio or live broadcast. Then at step 239, Client received notification about Seller's answer. If Client got back to the request window in step 241, then at step 243 Client received answer to the question in real-time mode on the site/mobile application of the store.

Going back to step 237, if the Seller is not available and did not answer the question immediately with photo/video, audio or live broadcast in step 237, then at step 245, Client left the site. At step 247, when the Seller has replied, Client will receive notification and email letter about answer for getting back to the site/application. If Client got back to the site/mobile application in step 249, then in step 251, Client received answer to the question in real-time mode on the site/mobile application of the store.

If If Client has closed the Eyezon window at step 207 and Client did not turn PUSH notification on and did not give email address, then, at step 253, Seller received notification with Client question through Eyezon service. If the Seller is available, at step 255 Seller answered the question immediately with photo/video, audio or live broadcast. Then then at step 257, Client received answer to the question in real-time mode on the site/mobile application of the store. Otherwise, at step 259 Client left the site.

The claimed group of inventions is interconnected so much that they form a single inventive concept.

Analysis of the combination of all essential features of the proposed technical solution proves that the exclusion of at least one of them leads to the impossibility of ensuring the achieved technical result.

Analysis of the prior art shows that such a group of the claimed inventions having features identical to all essential features of the given technical solution, is not known, which indicates that the given group of the claimed inventions is unknown and, therefore, has novelty.

The claimed group of inventions meets the criterion of inventive step, since for person skilled in the art it obviously does not follow from the prior art.

When implementing the group of inventions, the presence of the proposed object is actually realized, which indicates industrial applicability.

1.-2. (canceled)

3. A method for providing information comprising:
Entering on a user device a setup request on a webpage associated with a product;
Receiving the setup request regarding the product at a server;
Searching a database for sellers of the product;
Identifying at least one seller of the product;
Providing to the user an interface for entering a request for information;
Entering a request for information regarding the product through the interface;
Sending the request for information to the server;
Receiving the request for information by the server;
Forwarding the request for information to the at least one seller of the product;
Receiving the request for information on a device of the at least one seller of the product;
Receiving a decision from the at least one seller of the product whether to accept or reject the request for information;
If the at least one seller of the product accepts the request for information, processing the request for information, setting up a communications channel between the user and the at least one seller of the product, receiving a selection of a live broadcast option from the at least one seller of the product, turning on a camera on the device of the at least one seller of the product, sending a request for a live broadcast channel from the server to a broadcast server, establishing the live broadcast channel by the broadcast server, transmitting a link to the live broadcast channel to the server from the broadcast server, transmitting the link to the live broadcast channel to the user device from the server, connecting the user device to the live broadcast channel through the link; establishing video and audio communication between the user and the at least one seller of the product through the live broadcast channel.

4. The method of claim 3, wherein entering on a user device a setup request on a webpage associated with a product comprises pressing a button on the webpage.

5. The method of claim 3, wherein entering a request for information comprises pressing a button on the webpage.

6. The method of claim 3, wherein the product comprises a service.

7. The method of claim 3, wherein the webpage associated with a product comprises a mobile application page.

8. The method of claim 3, wherein the communications channel between the user and the at least one seller of the product is capable to communicate at least one of photo files, audio files, video files, or live audio and video broadcasting.

9. The method of claim 3, wherein the connecting the user device to the live broadcast channel through the link comprises opening up a new browser window on the user device.

10. The method of claim 9, wherein the connecting the user device to the live broadcast channel through the link further comprises turning on on the user device a camera and microphone.

11. The method of claim 3, wherein the request for information comprises a text message, an email, or an SMS message.

12. The method of claim 3, wherein the request for information comprises a request for advice.

13. The method of claim 3, wherein the webpage associated with a product is a webpage of an online store.

14. The method of claim 3, wherein the receiving the request for information on a device of the at least one seller of the product comprises receiving a push notification on a device of the at least one seller of the product.

15. The method of claim 3, further comprising turning push notification on the user device and providing email address of the user.

16. The method of claim 3, further comprising turning push notification on the user device.

17. The method of claim 3, wherein the interface for entering a request for information comprises a pop-up window.

18. The method of claim 3, wherein the interface for entering a request for information comprises a text or audio communication channel.

19. The method of claim 3, wherein the establishing video and audio communication between the user and the at least one seller of the product through the live broadcast channel is performed in the interface.

20. The method of claim 3, further comprising receiving a response from at least one seller of the product to the information request via email message.

21. A system for providing information comprising:
A streaming server;
A database communicatively coupled to the streaming server; and
A server communicatively coupled to the streaming server, the server configured with a non-transitory computer readable medium having stored thereon computer instructions, which upon execution by a central processing engine, cause the central processing engine to execute one or more applications for providing information comprising:
Receiving at the server a setup request regarding a product on a webpage associated with the product entered on a user device;
Searching the database for sellers of the product;
Identifying at least one seller of the product;
Providing to the user device an interface for entering a request for information;
Receiving by the server a request for information regarding the product entered on the user device through the interface;
Forwarding the request for information to the at least one seller of the product;
Receiving the request for information on a device of the at least one seller of the product;
Receiving a decision from the at least one seller of the product whether to accept or reject the request for information;
If the at least one seller of the product accepts the request for information, processing the request for information, setting up a communications channel between the user device and the at least one seller of the product, receiving a selection of a live broadcast option from the at least one seller of the product, turning on a camera on the device of the at least one seller of the product, sending a request for a live broadcast channel from the server to the streaming server, establishing the live broadcast channel by the streaming server, transmitting a link to the live broadcast channel to the server from the streaming server, transmitting the link to the live broadcast channel to the user device from the server, connecting the user device to the live broadcast channel through the link; establishing video and audio communication between the user and the at least one seller of the product through the live broadcast channel.

22. A system for obtaining advice regarding a product or service upon request in online broadcast mode, the system comprising:
A Client device;
At least one Seller device;
A Main server;
A Streaming server;
A Main server database;
A Streaming server database;
wherein at the setup stage:
the Client device enters a website or mobile application of a store and selects a product page on the website; when a button on the product page is pressed, the Client device sends a request to the main server, the main server processes the request and performs a search in the main server database for the seller device associated with the product page through the button, the main server returns a response to the Client device and interface with a field for entering an information request is loaded on the client device,
wherein at the step of sending the information request:
the Client device enters the information request in the field for entering information requests upon pressing a send button, the Client device sends the information request to the main server, the main server processes the information request and forwards it to the at least one seller device;
wherein at the step of responding to the information request:
if the at least one seller device chooses to respond to the information request, then the at least one seller device sends a first response to the main server; the main server processes the first response, creates a communication channel between the at least one seller device and the client device,
upon clicking on a Live broadcast button, the at least one seller device sends a broadcast request to the main server and opens a camera, the main server processes the broadcast request and sends a followup request to the streaming server, the streaming server generates a link to the live broadcast, the streaming server responds to the broadcast request of the main server and transmits to it the link to the live broadcast,
wherein at the step of receiving a response:
the main server transmits the received link to the client device; the client device receives a notification about the start of the live broadcast, upon pressing a broadcast button on the client device, a window is opened on the client device for the live broadcast from the at least one seller device, wherein the client device can use an input field in the window to communicate with the at least one seller device during the live broadcast.
